(19) United States
(12) Patent Application Publication
(10) Pub. No.: US 2026/0075297 A1
(43) Pub. Date: Mar. 12, 2026

(54) CAMERA MODULE

(71) Applicant: Samsung Electro-Mechanics Co., Ltd., Suwon-si (KR)

(72) Inventors: Inkyun PARK, Suwon-si (KR); Cheong Hee LEE, Suwon-si (KR)

(73) Assignee: Samsung Electro-Mechanics Co., Ltd., Suwon-si (KR)

(21) Appl. No.: 19/169,526

(22) Filed: Apr. 3, 2025

(30) Foreign Application Priority Data
Sep. 6, 2024 (KR) 10-2024-0121485

(51) Int. Cl. H04N 23/52

(52) U.S. Cl. CPC H04N 23/52

(57) ABSTRACT

A camera module is provided. The camera module includes a lens barrel; and a case that includes an upper case and a lower case surrounding at least a portion of the lens barrel and configured to be coupled to each other. The lower case includes a lower coupling portion that is coupled to the upper case, and the lower coupling portion includes a first coupling portion that is in direct contact with the upper case, and a second coupling portion that is coupled to the upper case through an adhesive, and the first coupling portion is electrically connected to the upper case.

### CROSS-REFERENCE TO RELATED APPLICATIONS

This application claims the benefit under 35 USC § 119(a) of Korean Patent Application No. 10-2024-0121485 filed on Sep. 6, 2024, in the Korean Intellectual Property Office, the entire disclosure of which is incorporated herein by reference for all purposes.

### BACKGROUND

### 1. Field

The following description relates to a camera module.

### 2. Description of Related Art

The development and implementation of ultra-small camera modules in vehicles has increased. For example, ultra-small cameras may be implemented for a black box camera that may be used for protection of the vehicle, or may be used to capture objective data with regard to a traffic accident, to operate as a rear surveillance camera that allows a driver to monitor a blind spot at a rear position of the vehicle through a screen to ensure safety when the vehicle is in reverse, a perimeter detection camera that monitors the vehicle's surroundings, or similar operations.

In order for the camera provided in the vehicle to be stably operated, electromagnetic interference (EMI) performance and Electromagnetic Compatibility (EMC) performance are important. To improve EMI and EMC performance, it is beneficial to shield an electric signal, and current conduction (or electric conduction) between an upper case and a lower case should be maintained to shield the electric signal.

In order to maintain the current conduction when the upper case and the lower case are typically assembled, a surface-treatment portion for corrosion prevention applied to the upper case and the lower case was removed, and the upper case and the lower case were bonded using a conductive adhesive. The method has a problem in which process efficiency is low, cost is increased due to use of the conductive adhesive, and the EMI and EMC performance are not very high.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a lens barrel; and a case that surrounds at least a portion of the lens barrel, and the case comprises an upper case and a lower case that are coupled to each other, wherein the lower case comprises a lower coupling portion that is coupled to the upper case, and the lower coupling portion includes a first coupling portion that is in direct contact with the upper case, and a second coupling portion that is coupled to the upper case by an adhesive, wherein the first coupling portion is electrically connected to the upper case.

The adhesive may be a non-conductive adhesive.

The lower case may include a first inner metal layer and a first insulating film layer disposed on a surface of the first inner metal layer, and the first coupling portion is a portion in which the first inner metal layer is exposed through a surface of the first coupling portion.

The second coupling portion may have a second insulating film layer on a surface thereof, and the lower case is coupled to the upper case through the second insulating film layer and the adhesive.

The upper case may include a second inner metal layer, a second insulating film layer disposed on a surface of the second inner metal layer, and an upper coupling portion that corresponds to the lower coupling portion, and the upper coupling portion may include a third coupling portion that corresponds to the first coupling portion of the lower coupling portion, and the second inner metal layer is exposed to a surface of the lower coupling portion.

The upper coupling portion may further include a fourth coupling portion that corresponds to the second coupling portion and which has the second insulating film layer on a surface thereof.

The upper coupling portion may be configured to accommodate the lower coupling portion.

The upper coupling portion may be disposed at a groove disposed on the upper case.

The first coupling portion may be disposed above the second coupling portion.

The second coupling portion may have a portion whose width gradually decreases toward the first coupling portion.

The upper case may include an upper surface portion; an upper side surface portion that extends from the upper surface portion toward the lower case; and an upper coupling portion that is disposed on a lower surface of the upper side surface portion.

The lower case may further include a lower surface portion and a lower side surface portion that extends from the lower surface portion toward the upper case, and the lower coupling portion protrudes from an upper surface of the lower side surface portion.

Other features and aspects will be apparent from the following detailed description, the drawings, and the claims.

### BRIEF DESCRIPTION OF DRAWINGS

FIG. 1 illustrates a schematic exploded perspective view of an example camera module, in accordance with one or more embodiments.

FIG. 2 is a perspective view illustrating an upper case shown in FIG. 1.

FIG. 3 is a bottom perspective view illustrating the upper case shown in FIG. 1.

FIG. 4 is a perspective view illustrating a lower case shown in FIG. 1.

FIG. 5 illustrates a cross-sectional view of the upper case and the lower case coupled to each other.

FIG. 6 is a view showing an example of a portion A of FIG. 5.

FIG. 7 is a view showing another example of the portion A of FIG. 5.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present. As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, the phrase “in a plan view” or “on a plane” may mean when an object portion is viewed from above, and the phrase “in a cross-sectional view” or “on a cross-section” may mean when a cross-section taken by vertically cutting an object portion is viewed from the side.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, an optical axis may be set as a central axis of a lens perpendicular to a surface of the lens, and a direction of the optical axis may mean a direction parallel to the central axis. In the drawings, the optical axis may be set to a Z-axis, and an X-axis and a Y-axis may be set in directions perpendicular to the optical axis. In this example, the X-axis and Y-axis may be perpendicular to each other, and an XY plane formed by the X-axis and Y-axis may become a plane perpendicular to the optical axis.

One or more examples may provide a camera module that increases process efficiency, reduces cost, and improves electromagnetic interference (EMI) performance and Electromagnetic Compatibility (EMC) performance.

In accordance with the one or more examples, a non-conductive adhesive that is cheaper than a conductive adhesive may be used so that there is a cost reduction effect.

In accordance with the one or more examples, a peeling portion for surface treatment of the upper and lower cases may be reduced so that process efficiency is improved.

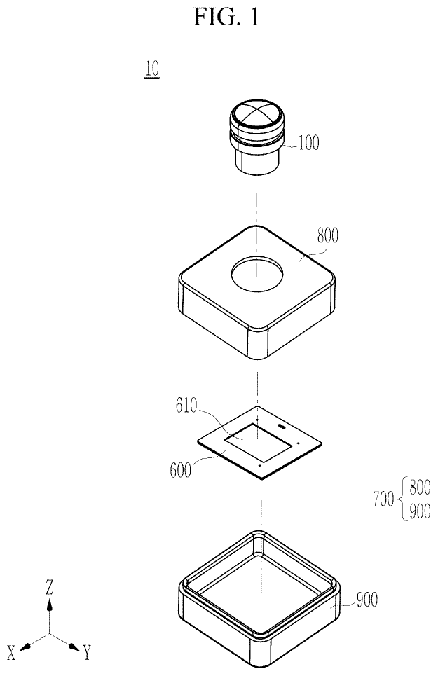

FIG. 1 is a schematic exploded perspective view of an example camera module 10, in accordance with one or more embodiments.

Referring to FIG. 1, the camera module 10, in accordance with one or more embodiments, may include a lens barrel 100, a substrate 600, an image sensor 610, and a case 700. Additionally, the camera module 10, in accordance with one or more embodiments, may further include a heating member and a heat insulating member. The camera module 10, in accordance with one or more embodiments, may be implemented except for some of the above components, and does not exclude additional components.

The camera module 10 may include the lens barrel 100. At least a portion of the lens barrel 100 may be accommodated in the case 700. The case 700 may be disposed to surround at least a portion of the lens barrel 100. A portion of the lens barrel 100 may be inserted into an inner space of the case 700 through an opening formed at the case 700, and another portion of the lens barrel 100 may be disposed on the case 700.

The lens barrel 100 may include at least one lens. Each lens of the lens barrel 100 may be made of a synthetic resin material, a glass material, a quartz material, or similar materials, but is not limited thereto, and may be made of various other materials.

The substrate 600 may be disposed inside the case 700. The substrate 600 may be disposed below the lens barrel 100. The substrate 600 may include a printed circuit board (PCB) or a flexible printed circuit board (FPCB), as examples.

Although not shown in the drawings, the camera module 10 may include a heating member and a connection member coupled to the heating member. The connection member may be electrically connected to the substrate 600.

The image sensor 610 may be disposed inside the case 700. The image sensor 610 may convert light incident through the lens barrel 100 into an electric signal. The image sensor 610 may be mounted on the substrate 600. The image sensor 610 may be electrically connected to the substrate 600. The image sensor 610 may be disposed on a front surface or an upper surface of the substrate 600. For example, the image sensor 610 may be coupled to the substrate 600 using a surface mounting technology (SMT). As another example, the image sensor 610 may be coupled to the substrate 600 using a flip chip technology. For example, the image sensor 610 may be any one of a charge-coupled device (CCD), a metal oxide semi-conductor (MOS), a CMOS photo detector (CPD), and a charge injection device (CID), but is not limited thereto. The electric signal converted by the image sensor 610 may be output as an image through a display unit (or a display) of an electronic device. The image sensor 610 and the lens may be aligned in the optical axis direction (the Z-axis direction).

Although not shown in the drawings, an optical filter may be disposed between the lens barrel 100 and the image sensor 610. The optical filter may block light of a specific frequency band among light passing through the lens from entering the image sensor 610. The optical filter may be disposed parallel to a direction perpendicular to the optical axis direction (the Z-axis direction). The optical filter may include an infrared-blocking filter, as an example. The image sensor 610, the lens, and the optical filter may be aligned in the optical axis direction (the Z-axis direction).

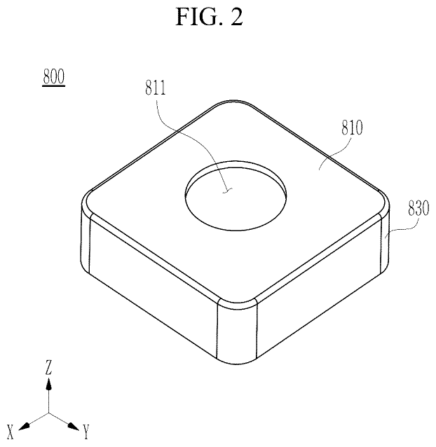

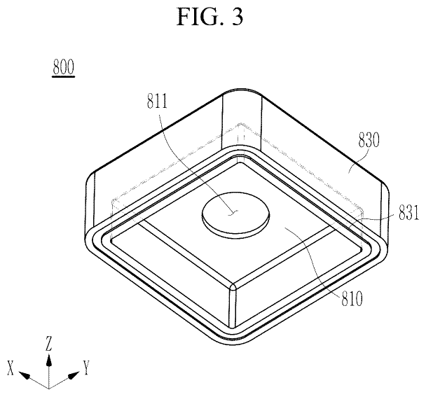

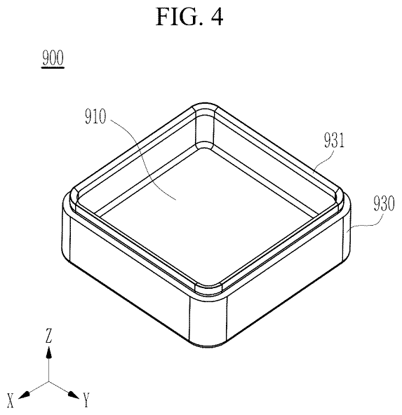

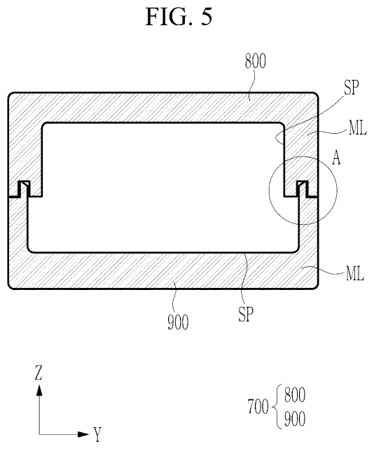

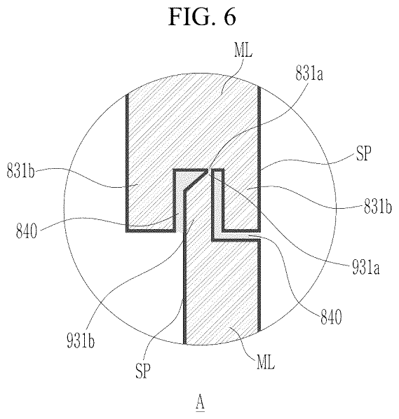

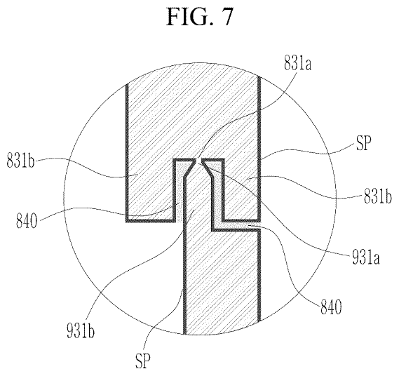

FIG. 2 is a perspective view illustrating an upper case 800 shown in FIG. 1. FIG. 3 is a bottom perspective view illustrating a bottom surface of the upper case 800 of FIG. 1 and FIG. 2. FIG. 4 is a perspective view illustrating a lower case 900 shown in FIG. 1. FIG. 5 is a cross-sectional view showing the upper case 800 and the lower case 900 coupled to each other. FIG. 6 is an enlarged view illustrating an example of a coupling portion (i.e., a portion A) of FIG. 5. FIG. 7 is an enlarged view illustrating another example of the coupling portion (the portion A) of FIG. 5.

The case 700 may protect an internal component of the camera module 10. The case 700 may operate to shield an electromagnetic wave. For example, the case 700 may shield the electromagnetic wave so that the electromagnetic wave generated by the camera module 10 does not affect another electronic component within an electronic device. The case 700 may include the upper case 800 and the lower case 900. The upper case 800 and the lower case 900 may be coupled to each other to form an internal space to accommodate a component of the camera module.

Referring to FIG. 6, the case 700 may include an inner metal layer (ML) and an insulating film layer (SP) disposed on a surface of the inner metal layer (ML).

Referring to FIG. 1 and FIG. 4, the lower case 900 may be disposed below the substrate 600. The lower case 900 may support the substrate 600 from below. The lower case 900 may be coupled to the upper case 800. The lower case 900 may have a shape corresponding to the upper case 800. The lower case 900 may have a box shape having an open upper portion and four corners. The lower case 900 may be coupled to the upper case 800 to shield an electric signal or to shield an electromagnetic wave.

Referring to FIG. 5, the lower case 900 may include an inner metal layer (ML) and an insulating film layer (SP) disposed on a surface of the inner metal layer (ML). The inner metal layer (ML) of the lower case 900 may be formed of a plate of a metallic material, or may be formed of a material having a low corrosion rate such as stainless steel.

Referring to FIG. 4, the lower case 900 may include a lower surface portion 910 and a lower side surface portion 930.

The lower surface portion 910 may be disposed along a planar direction (i.e., an XY-axis direction). The lower surface portion 910 may be disposed along a direction perpendicular to the optical axis direction (the Z-axis direction). The lower surface portion 910 may have a quadrangular shape, and a corner portion of the lower surface portion 910 may have a rounded shape. The lower side surface portion 930 may be coupled to an upper side surface portion 830. The lower side surface portion 930 may extend upward along the optical axis direction (the Z-axis direction) from the lower surface portion 910. That is, the lower side surface portion 930 may extend in a direction from the lower surface portion 910 toward the upper case 800. For example, the lower side surface portion 930 may have four surfaces, and adjacent surfaces of the four surfaces may be perpendicular to each other. A corner portion connected to the surfaces of the lower side surface portion 930 may have a round shape to correspond to a shape of the corner portion of the lower surface portion 910. The lower case 900 may have a quadrangular box shape with an open upper portion and a round corner. However, a shape of the lower case 900 is not limited thereto.

The lower case 900 may have a lower coupling portion 931. The lower coupling portion 931 may be a coupling protrusion that protrudes upward from an upper end of the lower side surface portion 930. The lower coupling portion 931 may be disposed at an inner portion of an upper surface of the lower side surface portion 930. The lower coupling portion 931 may protrude upward from the inner portion on the upper surface of the lower side surface portion 930. The lower coupling portion 931 may be formed in a shape in which the inner portion of the entire upper surface of the lower side surface portion 930 protrudes in a direction toward the upper case 800. The lower coupling portion 931 may be a portion that is coupled to the upper case 800. The lower coupling portion 931 may have a portion in line contact with the upper case 800. For example, the lower coupling portion 931 may have a coupling protrusion shape that is coupled to a portion of the upper case 800 corresponding to the lower coupling portion 931, and an end portion of the lower coupling portion 931 may be formed to be sharp. The lower coupling portion 931 may have a portion whose width becomes narrower toward an end portion thereof. The lower coupling portion 931 may be formed on the entire inner side of the upper surface of the lower side surface portion 930. That is, the lower coupling portion 931 may have a closed-loop shape.

Referring to FIG. 1, FIG. 2, and FIG. 3, the upper case 800 may be disposed to surround at least a portion of the lens barrel 100. The upper case 800 may have a box shape having an open lower portion and four corners. The upper case 800 may have a central opening. A central opening of a lens barrel 100 and the central opening of the upper case may be aligned along the optical axis direction (the Z-axis direction).

Referring to FIG. 5, the upper case 800 may include an inner metal layer (ML) and an insulating film layer (SP) disposed on a surface of the inner metal layer (ML). The inner metal layer (ML) of the upper case 800 may be formed of a plate of a metallic material, or may be formed of a material having a low corrosion rate such as stainless steel.

Referring to FIG. 2, the upper case 800 may include an upper surface portion 810 and an upper side surface portion 830.

The upper surface portion 810 may be disposed along the planar direction (the XY-axis direction). The upper surface portion 810 may be disposed along a direction perpendicular to the optical axis direction (the Z-axis direction). The upper surface portion 810 may face the lower surface portion 910. The upper surface portion 810 may have a quadrangular shape, and a corner portion of the upper surface portion 810 may have a rounded shape. A cover opening 811 may be formed at a central portion of the upper surface portion 810. A central portion of the lens barrel may be exposed through the cover opening 811, and the lens may also be exposed so that light may be incident thereon.

The upper side surface portion 830 may extend downward along the optical axis direction (the Z-axis direction) from the upper surface portion 810. That is, the upper side surface portion 830 may extend in a direction from the upper surface portion 810 toward the lower case 900. For example, the upper side surface portion 830 may have four surfaces, and adjacent surfaces of the four surfaces may be perpendicular to each other. A corner portion connected to the surfaces of the upper side surface portion 830 may have a round shape to correspond to a shape of the corner portion of the upper surface portion 810. The upper case 800 may have a quadrangular box shape with an open lower portion and a round corner. However, a shape of the upper case 800 is not limited thereto.

Referring to FIG. 3, the upper case 800 may have an upper coupling portion 831. The upper coupling portion 831 may be disposed at a lower end of the upper side surface portion 830. The upper coupling portion 831 may correspond to the lower coupling portion 931. The upper coupling portion 831 may be formed at a position corresponding to the lower coupling portion 931. The upper coupling portion 831 may accommodate the lower coupling portion 931. The upper coupling portion 831 may be a coupling groove formed to be concave toward the inside of the upper side surface portion 830. The upper coupling portion 831 may be a portion that is coupled to the lower case 900. The upper coupling portion 831 may be a trench that is formed at a lower end portion of the upper side surface portion 830. The upper coupling portion 831 may be a trench that is along the entire lower end of the upper side surface portion 830.

The upper coupling portion 831 may be disposed at a central portion of a lower surface of the upper side surface portion 830. The upper coupling portion 831 may be concavely formed at the central portion of the lower surface of the upper side surface portion 830. The upper coupling portion 831 and the lower coupling portion 931 may have portions that are in line contact with each other. The upper coupling portion 831 may be formed along the entire central portion of the lower surface of the upper side surface portion 830. That is, the upper coupling portion 831 may have a closed-loop shape.

Referring to FIG. 6, an adhesive 840 may be interposed between the upper coupling portion 831 and the lower coupling portion 931. The adhesive 840 may bind the upper coupling portion 831 and the lower coupling portion 931. In an example, the adhesive 840 may be disposed at only a portion of the upper coupling portion 831 and only a portion of the lower coupling portion 931. In an example, the adhesive 840 may be a non-conductive adhesive.

Referring to FIG. 5, FIG. 6, and FIG. 7, the lower coupling portion 931 may include a first coupling portion 931a and a second coupling portion 931b, and the upper coupling portion 831 may include a third coupling portion 831a corresponding to the first coupling portion 931a and a fourth coupling portion 831b corresponding to the second coupling portion 931b.

The first coupling portion 931a and the third coupling portion 831a may be portions where the inner metal layer (ML) of the lower case 900 (for example, a first inner metal layer) and the inner metal layer (ML) of the upper case 800 (for example, a second inner metal layer) are each exposed to surfaces of the first coupling portion 931a and the third coupling portion 831a, or where the inner metal layer (ML) of the lower case 900 and the inner metal layer (ML) of the upper case 800 connect each other between surfaces of the first coupling portion 931a and the third coupling portion 831a. That is, surfaces of the first coupling portion 931a and the third coupling portion 831a may be formed of a metal material. The first coupling portion 931a and the third coupling portion 831a may be each formed by partially removing insulating film layers SP disposed on surfaces of the lower coupling portion 931 and the upper coupling portion 831. For example, a continuous inner metal layer (ML) may be formed to connect the first coupling portion 931a and the third coupling portion 831a. A portion of the lower coupling portion 931 from which the insulating film layer SP is removed may be the first coupling portion 931a. A portion of the upper coupling portion 831 from which the insulating film layer SP is removed may be the third coupling portion 831a. The first coupling portion 931a and the third coupling portion 831a may be in direct contact with each other via the inner metal layer (ML) to electrically conduct the lower case 900 and the upper case 800.

The first coupling portion 931a may be disposed at an uppermost end of the lower coupling portion 931. The first coupling portion 931a may be disposed above the second coupling portion 931b. The second coupling portion 931b may be disposed below the first coupling portion 931a. The second coupling portion 931b may have the insulating film layer SP on a surface thereof. A portion of the lower coupling portion 931 from which the insulating film layer SP of an upper surface thereof is removed may be the first coupling portion 931a, and a portion below the first coupling portion 931a from which the insulating film layer SP is not removed, (for example, a first insulating film layer), may be the second coupling portion 931b. The second coupling portion 931b may have a portion whose width gradually decreases from the bottom to the top of the second coupling portion 931b. The second coupling portion 931b may have a portion whose width gradually decreases toward the first coupling portion 931a. The second coupling portion 931b may have a portion that is inclined toward the first coupling portion 931a. In an example, the inclination may be formed on only one side based on the first coupling portion 931a (see FIG. 6), or may be formed on both sides based on the first coupling portion 931a (see FIG. 7).

The third coupling portion 831a may correspond to the first coupling portion 931a. The third coupling portion 831a may be disposed at a position corresponding to the first coupling portion 931a to be in direct contact with the first coupling portion 931a. A metal on a surface of the third coupling portion 831a and a metal on a surface of the first coupling portion 931a may be in direct contact with each other. Accordingly, the upper case 800 and the lower case 900 may be electrically conducted. The first coupling portion 931a and the third coupling portion 831a may be in line contact with each other. The fourth coupling portion 831b may correspond to the second coupling portion 931b. The fourth coupling portion 831b may be disposed at a position corresponding to the second coupling portion 931b. The fourth coupling portion 831b may face the second coupling portion 931b with the adhesive 840 interposed therebetween. The adhesive 840 may not be disposed between the third coupling portion 831a and the first coupling portion 931a, but may be disposed only between the fourth coupling portion 831b and the second coupling portion 931b. The fourth coupling portion 831b may have the insulating film layer SP, (for example, a second insulating film layer), on a surface thereof. A portion of the upper coupling portion 831 from which the insulating film layer SP is removed may be the third coupling portion 831a, and a portion of the third coupling portion 831a disposed on both sides of the third coupling portion 831a from which the insulating film layer SP is not removed may be the fourth coupling portion 831b.

In the camera module of the one or more examples, metal portions (ML) of the upper case and the lower case may be in direct contact with each other to be electrically conducted. Therefore, because it is not necessary to provide an electric conductivity to the adhesive to bond the upper case and the lower case, the non-conductive adhesive, which is cheaper than a conductive adhesive may be used when the camera module is manufactured.

Additionally, because the insulating film layer disposed at the remaining portion except for a first portion of the upper coupling portion and a first region (or a first portion) of the lower coupling portion does not need to be peeled off, a portion requiring a peeling process may be reduced. Thus, process efficiency may be improved.

Additionally, because the metal portions of the upper case and the lower case are in direct contact, electromagnetic interference (EMI) of the camera module may be reduced, and Electromagnetic Compatibility (EMC) of the camera module may be improved.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a lens barrel; and
a case that surrounds at least a portion of the lens barrel, and the case comprises an upper case and a lower case that are coupled to each other,
wherein the lower case comprises a lower coupling portion that is coupled to the upper case, and the lower coupling portion comprises:
a first coupling portion that is in direct contact with the upper case, and
a second coupling portion that is coupled to the upper case by an adhesive,
wherein the first coupling portion is electrically connected to the upper case.

2. The camera module of claim 1, wherein the adhesive is a non-conductive adhesive.

3. The camera module of claim 1, wherein the lower case comprises a first inner metal layer and a first insulating film layer disposed on a surface of the first inner metal layer, and the first coupling portion is a portion in which the first inner metal layer is exposed through a surface of the first coupling portion.

4. The camera module of claim 1, wherein the second coupling portion has a second insulating film layer on a surface thereof, and the lower case is coupled to the upper case through the second insulating film layer and the adhesive.

5. The camera module of claim 1, wherein the upper case comprises a second inner metal layer, a second insulating film layer disposed on a surface of the second inner metal layer, and an upper coupling portion that corresponds to the lower coupling portion, and
wherein the upper coupling portion comprises a third coupling portion that corresponds to the first coupling portion of the lower coupling portion, and the second inner metal layer is exposed to a surface of the lower coupling portion.

6. The camera module of claim 5, wherein the upper coupling portion further comprises a fourth coupling portion that corresponds to the second coupling portion and which has the second insulating film layer on a surface thereof.

7. The camera module of claim 6, wherein the upper coupling portion is configured to accommodate the lower coupling portion.

8. The camera module of claim 5, wherein the upper coupling portion is disposed at a groove disposed on the upper case.

9. The camera module of claim 1, wherein the first coupling portion is disposed above the second coupling portion.

10. The camera module of claim 1, wherein the second coupling portion has a portion whose width gradually decreases toward the first coupling portion.

11. The camera module of claim 1, wherein the upper case comprises:
an upper surface portion;
an upper side surface portion that extends from the upper surface portion toward the lower case; and
an upper coupling portion that is disposed on a lower surface of the upper side surface portion.

12. The camera module of claim 1, wherein the lower case further comprises a lower surface portion and a lower side surface portion that extends from the lower surface portion toward the upper case, and the lower coupling portion protrudes from an upper surface of the lower side surface portion.
